(19) United States
(12) Patent Application Publication
(10) Pub. No.: US 2026/0347548 A1
(43) Pub. Date: Nov. 5, 2026

(54) METHOD FOR THE PREPARATION OF KERATIN-CONTAINING MATERIAL WITH IMPROVED PROPERTIES VIA "GRAFTING FROM" POLYMERIZATION AND THE OBTAINED KERATIN-CONTAINING MATERIAL

(71) Applicants: UNIVERSITA' DEGLI STUDI DI MILANO - BICOCCA (69%), MILANO (IT); FONDAZIONE ISTITUTO ITALIANO DI TECNOLOGIA (30%), GENOVA (IT); FONDAZIONE CARIPLO (1%), MILANO (IT)

(72) Inventors: Giovanni Perotto, Genova (IT); Dagmara Jadwiga Trojanowska, Milano (IT); Arkadiusz Zych, Genova (IT); Athanasia Athanasiou, Genova (IT); Roberto Simonutti, Milano (IT)

(73) Assignees: Universita' degli Studi Di Milano-Bicocca (69%), Milano (IT); Fondazione Istituto Italiano di Tecnologia (30%), Genova (IT); Fondazione Cariplo (1%), Milano (IT)

(21) Appl. No.: 19/486,638

(22) PCT Filed: May 23, 2024
(86) PCT No.: PCT/IB2024/055011

§ 371 Date: Nov. 21, 2025

(30) Foreign Application Priority Data
May 24, 2023 (IT) 102023000010470

(51) Int. Cl. C08H 1/06; C08L 89/04

(52) U.S. Cl. CPC C08H 1/06; C08L 89/04

(57) ABSTRACT

The present invention relates to a method of processing keratin extracted from keratin-rich waste, particularly originating from wool and/or feathers biomass, and turning it into bioplastic materials by chemical modification, namely by using the “grafting from” chemistry polymerization. The method for the preparation of a keratin-based material of the present invention comprises the following steps: a) obtaining keratin micro- and/or nanoparticles from a keratin-rich waste; b) grafting the keratin micro- and/or no particles via the “grafting from” polymerization, with at least one monomer capable of ring opening polymerization and in presence of a catalyst; and c) obtaining a keratin-based material. The keratin-based material obtainable according to the method above described, preferably a film or a composite film, is also an objected of the invention.

### FIELD OF INVENTION

The present invention relates to a method for the preparation of a renewable and sustainable keratin-based material, by direct conversion of keratin-rich waste, particularly originating from wool and/or feathers biomass, using the “grafting from” chemistry polymerization.

The invention relates also to the keratin-based material obtained with the method of the invention, which is a protein-based bioplastic and can be used to replace oil-based plastics.

### BACKGROUND OF THE INVENTION

The awareness of plastic pollution became highly pronounced in the last decade, causing the need for more sustainable alternatives, particularly more sustainable sources of raw materials. The final aim of this invention contributes to the effort the industry is making for changing paradigm from the old use-dispose economic systems to a new closed-loop system based on new technologies that can convert the waste into value-added products that can go back in the system loop. The textile and poultry industry generate easily accessible low-grade wool and feather waste composed by more than 90% by weight of one type of protein: keratin. The conventional methods of this waste elimination, such as disposal at the landfills or incinerating, are unprofitable and raise environmental concerns. Therefore, the development of appropriate technologies to upscale waste into value-added final products is greatly needed. Proteins have not been widely explored as a source of raw materials and can be considered a renewable resource. Hence, proteins, including keratin, that are biodegradable, possess a high degree of functionality and show good mechanical properties; they are good candidates to be investigated and engineered as plastics. Therefore, keratin is well suited for use as a foundation in the design of closed-loop sustainable systems and the development of naturally derived products that can be returned to the cycle at the end of their life. Suitable application of keratin encourages continual use of resources and waste reduction.

“Grafting from” approach involves in situ polymerization of a monomer directly from the nanoparticles and surfaces; hence it is widely used for their decoration (Rubio, N. et al., Grafting from versus Grafting to Approaches for the Functionalization of Graphene Nanoplatelets with Poly(methyl methacrylate). Macromolecules (2017), vol. 50(18), p. 7070-7079). The “grafting from” approach was used for the recovery of natural polymers or macromolecules present in the waste and the transformation thereof into thermoplastic materials through grafting of biodegradable polymers. Several examples have been described in the literature.

The “grafting from” polymerization has been explored to modify natural or biobased polymers, including cellulose or lignin. Moreover, several reports described protein-assisted ring opening polymerization (ROP).

However, none of the papers describes the method of keratin modification by the “grafting from” approach and keratin-mediated ROP.

In view of the prior art, the need of renewable and sustainable keratin-based materials, namely flexible freestanding thermoplastic materials (protein bioplastics), obtained from keratin-rich waste, preferably from wool or feathers waste biomass remains.

CN101284948 relates to a composite film made of poultry keratin prepared by reduction ultrasonic hydrolysis or oxidative ultrasonic hydrolysis and a preparation method thereof, wherein a film former is used to obtain the film.

In Donato et al. (“Keratin Associations with Synthetic, Biosynthetic and Natural Polymers: An Extensive Review”, Polymers (2020), 12, 32; 1084), keratin's compatibility with other synthetic, biosynthetic and natural polymers is described and surface modification of keratin is obtained. This paper does not teach to obtain a keratin copolymer.

In Pulidori et al. (“Valorization of not soluble byproducts deriving from green keratin extraction from poultry feathers as filler for biocomposites”, Journal of Thermal Analysis and Calorimetry (2022) 147:5377-5390) a process to make natural, biodegradable, biocompatible, and eco-friendly composites from keratin (NSK) and poly(lactic acid) (PLA) is described. The paper shows the attainment of reinforced filaments.

In the present invention it has been found that the “grafting from” polymerization enables the conversion of the keratin particles into keratin-based material entirely made of biodegradable components, which show enhanced thermoplastic properties. According to a preferred embodiment of the present invention, a polyester, such as poly(lactic acid) (PLA), is grown directly on the particle or chain, using functional groups already present or specifically inserted as initiators by chemically modifying the macromolecular skeleton. PLA is an eco-friendly, biocompatible, biodegradable, easily processable and energy saving biopolymer, whose monomer unit, i.e. lactic acid, comes from natural sources (Drumright, R. E., P. R. Gruber, and D. E. Henton, Polylactic acid technology. Advanced materials (2000) vol. 12(23), p. 1841-1846; Auras, R., B. Harte, and S. Selke, An overview of polylactides including materials. Macromolecular bioscience (2004) vol. 4(9), p. 835-864).

In general, the poly(lactic acid) synthesis proceeds through ROP of lactide (lactic acid dimer) initiated by hydroxyl groups. In the process of the invention, the ROP of lactide is initiated by the hydroxyl group of serine, tyrosine or threonine, amino acids (or any other functional group capable to initiate ROP) present on keratin particles' surface (Yin, X.-C., et al., Study on effective extraction of chicken feather keratins and their films for controlling drug release. Biomaterials Science (2013) vol. 1(5), p. 528-536; Rajabinejad, H., et al., Physicochemical properties of keratin extracted from wool by various methods, Textile Research Journal (2018) vol. 88(21), p. 2415-2424).

The “grafting from” reaction needs a catalyst which for a long time was based on metals, but in the recent years, it has been replaced by organo-catalysts such as 1,8-diazabicyclo[5.4.0]undec-7-ene (DBU), capable of reducing reaction time and rise the control over the polymerization reaction (Nederberg, F., et al., New paradigms for organic catalysts: the first organocatalytic living polymerization. Angewandte Chemie International Edition, (2001) vol. 40(14), p. 2712-2715; Sherck, N. J., H. C. Kim, and Y.-Y. Won, Elucidating a unified mechanistic scheme for the DBU-catalyzed ring-opening polymerization of lactide to poly(lactic acid). Macromolecules, (2016) vol. 49(13), p. 4699-4713).

In the perspective of developing new packaging materials, which are biobased and biodegradable, the polymer composites with PLA grafted particles have been fabricated. As polymer matrices, biobased polymers like PLA and poly(butylene-adipate-co-terephthalate) (PBAT) were exploited (Jian, J., Z. Xiangbin, and H. Xianbo, An overview on synthesis, properties and applications of poly(butylene-adipate-co-terephthalate)-PBAT. Advanced Industrial and Engineering Polymer Research, (2020) vol. 3(1), p. 19-26).

Although completely biobased, PLA has very low degradation kinetics, whereas PBAT is only partially biobased but degrades fast and straightforwardly. PBAT is a random co-polyester used to produce food packaging (cling wrap), compostable bags and bags for gardening and agriculture, compostable shopping bags or as a resistant layer to water in the production of paper containers (generally cups or glasses). Its flexibility and biodegradability make it a suitable additive to be mixed with more rigid materials to increase their flexibility while maintaining biodegradability.

Therefore, according to a preferred embodiment, the present invention relates to composites of polymer, such as PLA or PBAT, with keratin/polymer (such as PLA) particles, prepared using solution casting method. The resulting films showed improved mechanical characteristics when compared to neat polymers used as a matrix in a composite formation.

### DEFINITIONS

Unless otherwise defined, all the terms of the art, notations and other scientific terms used herein are intended to have the meanings commonly understood by those who are experts in the technique to which this description belongs. In some cases, terms with commonly understood meanings are defined here for clarity and/or for ready reference; the inclusion of these definitions in this description should therefore not to be interpreted as representing a substantial difference with respect to what is generally understood in the art.

The terms “comprise”, “have”, “include”, “contain”, “comprising”, “having”, “including” and “containing” are to be understood as open terms (i.e. the meaning “comprising, but not limited to”) and are to be considered as a support also for terms such as “essentially consist of”, “consisting essentially of”, “consist of” or “consisting of”.

For all the ranges indicated in the text and in the claims of the present patent application, it is understood that the extremes of these ranges are included.

In the present invention, the terms “protein bioplastic” and “bioplastic material” are synonymous; they refer to a polymeric material, with plastic properties, which is obtained from chemically modified natural protein derivatives. Keratin-based materials of the invention, such as films can be referred to as a protein bioplastic or a bioplastic material.

The term “freestanding thermoplastic materials” means that the new keratin-based materials of the invention can also be freestanding like, e.g., a plastic sheet.

The acronym “ROP” means ring opening polymerization.

The acronym “PLA” means poly(lactic acid).

The acronym “DBU” means 1,8-diazabicyclo[5.4.0]undec-7-ene.

The acronym “TBD” means 1,5,7-triazabicyclo[4.4.0]dec-5-ene.

The acronym “mTBD” means 7-methyl-1,5,7-triazabicyclo[4.4.0]dec-5-ene.

The acronym “PBAT” means poly(butylene-adipate-co-terephthalate).

The term “lactide” refers to the cyclic ester 3,6-dimethyl-1,4-dioxane-2,5-dione.

The acronym “DMF” means N,N-dimethylformamide.

The acronym “DCM” means dichloromethane.

The acronym “THF” means tetrahydrofuran.

The acronym “DMSO” means dimethyl sulfoxide.

The acronym “PHA” means polyhydroxyalkanoate.

The acronym “PCL” means polycaprolactone.

The terms “keratin micro- and/or nanoparticles” refer to keratin particles in the range between 10 nm up to millimeters, preferably between 50 nm and 500 nm, preferably between 60 and 200 nm.

The term “keratin/polymer particles” refers to keratin micro- and/or nanoparticles grafted with at least one suitable polymer, preferably at least one biodegradable polymer, more preferably selected from polyesters, such as poly(lactic acid) (PLA), poly(butylene-adipate-co-terephthalate) (PBAT), polyhydroxyalkanoate (PHA) and/or polycaprolactone (PCL).

The term “keratin/PLA particles” refers to keratin micro- and/or nanoparticles grafted with PLA.

“Keratin in native form” refers to the material unmodified chemically.

The expression “keratin particles in native form” refers to particles produced from keratin-rich waste using mechanical methods.

The acronym “DPn” means degree of polymerization. In the present invention it is calculated using DSC using Flory-Fox equation. In the case of PLA, with a Mn in the order of about 4000 g/mol, DPn is equivalent to 50. To calculate it, the equation DPn=Mn/MO is used, whereas Mn is the number-average molecular weight (estimated from DSC), and MO is the molecular weight of the mer (repeating unit) lactic acid without water. In such a case, DPn=4000/(90.08-18)=55.5.

With the term “composite film”, it is intended a film obtained with the method of invention, wherein step b′) is present, namely wherein a further polymer have been added to the grafted micro- and/or nanoparticles obtained in step b).

With the term “reprocessing” it is intended a process which is able to change the shape of the material and to recycle it several times. The polymer of invention can be for example reprocessed using temperature. A process that can be used to reprocess the polymer of the invention is selected from extrusion, reactive extrusion, thermal compression, injection molding, injection stretch blow molding, blown film, casting, thermoforming, foaming, fibre spinning, blending, batch process and/or compounding process.

### SUMMARY OF INVENTION

The present invention relates to a method to process keratin extracted from keratin-rich waste, preferably from wool and/or feathers biomass, to obtain a bioplastic material by chemical modification, by using the “grafting from” chemistry approach.

The method for the preparation of a keratin-based material of the present invention comprises the following steps:
a) obtaining keratin micro- and/or nanoparticles from a keratin-rich waste;
b) grafting the keratin micro- and/or nanoparticles via “grafting from” polymerization, with at least one monomer capable of ring opening polymerization (ROP) and in presence of a catalyst; and
c) obtaining a keratin-based material.

Optionally, the method of the invention may comprise the step b′) before step c):
b′) mixing the grafted keratin micro and/or nanoparticles with at least one polymer, preferably at least one biodegradable polymer, and a solvent.

The keratin-based material obtainable according to the method above described, preferably obtained in the form of a film or a composite film, is also an object of the present invention.

### BRIEF DESCRIPTION OF THE FIGURES

The invention will be described hereinafter with reference to some examples, provided for explanatory and non-limiting purposes, and illustrated in the annexed figures.

FIG. 1—shows table 1 including the summary of hydrodynamic radii and PDI of keratin particles in various solvents.

FIG. 2—shows table 2 including the summary of polymerization conditions of keratin/PLA samples with different reaction time.

FIG. 3—shows table 3 including the summary of polymerization conditions of keratin/PLA samples with different reagents ratios.

FIG. 4—shows table 4 including the summary of repeated and optimized polymerization conditions of keratin/PLA samples.

FIG. 5—shows: a) Comparison of ¹H NMR spectrum of PLA_K3 with ¹H NMR spectrum of PLA); inserts display the enlarged resonances of the PLA backbone; b) Scheme of chemical structure of PLA obtained with DBU catalysis and benzyl alcohol as terminating agent. The marks: ▪, • and * indicate the different types of atoms seen in the NMR spectra.

FIG. 6—shows table 5 including experimental data from DSC analysis of the two sets on polymerization for the reaction time dependence determination.

FIG. 7—shows table 6 including experimental data from DSC analysis of polymerization reactions which study different [Monomer]/[Initiator] and [Initiator]/[catalyst] ratios.

FIG. 8—shows TGA curves of neat keratin (K), keratin/PLA particles (PLA_K2-PLA_K4) and neat PLA.

FIG. 9—shows table 7 including experimental values from TGA of the first set of polymerization about reaction time dependence.

FIG. 10—shows table 8 including experimental values from TGA of reactions which study different [M]/[I] and [I]/[DBU] ratios.

FIG. 11—shows the SEM images of keratin particles.

FIG. 12—shows SEM images of PLA-keratin particles, in the order: PLA_K3 and PLA_K6.

FIGS. 12a) and 12b)—SEM images of PLA-keratin particles: 12a) PLA_K3; and 12b) PLA_K6.

FIG. 13—shows TGA curves of samples before and after the purification process compared to the thermal degradation of PLA and keratin as reference system. Washed samples are labeled as LAV.

FIG. 14—shows table 9 including different PLA % after purification treatment.

FIG. 15—shows the films obtained with neat PLA and PLA mixing with an increased amount of grafted keratin particles (PLA_K): from left to right and top to down: pure PLA, PLA+PLA_K 1%, PLA+PLA_K 5%, PLA+PLA_K 10%, PLA+PLA_K 20%, PLA+PLA_K 30%.

FIG. 16—reports the stress-strain measurements on the films: FIG. 16a) selected stress-strain curves for PLA and PLA+PLA_K composites; FIG. 16b) shows the Young's Modulus of the composites; and FIG. 16c) shows the elongation at the break of the composites.

FIG. 17—shows the films obtained with PBAT: from left to right and top to down: pure PBAT, PBAT+PLA_K 1%, PBAT+PLA_K 5%, PBAT+PLA_K 10%, PBAT+PLA_K 20%, PBAT+PLA_K 30%.

FIG. 18—reports the stress-strain measurements on the films: FIG. 18a) selected stress-strain curves for PLA and PBAT+PLA_K composites; FIG. 18b) shows the Young's Modulus of the composites; and FIG. 18c) shows the elongation at the break of the composites.

FIG. 19—shows table 10 reporting mechanical properties of PLA, and PLA+PLA_K based composites.

FIG. 20—shows table 11 reporting mechanical properties of PBAT and PBAT+PLA_K based composites.

### DETAILED DESCRIPTION

The present invention relates to a method to make a bioplastic material starting from keratin extracted from a keratin-rich waste.

Preferably the keratin-rich waste is a wool and/or feathers biomass.

The method of the invention is a chemical reaction based on the “grafting from” chemistry concept.

This method has the potential to produce several keratin-based materials having different properties (such as biodegradability, flexibility or thermoplasticity), by combination with further polymers.

Surprisingly, the method of the invention based on the “grafting from” approach enables to obtain a more flexible, freestanding keratin-based film entirely made of biodegradable components, which show thermoplasticity and reprocessing, with respect to the brittle keratin films of the art.

The method for the preparation of a keratin-based material of the present invention comprises the following steps:
a) obtaining keratin micro- and/or nanoparticles from a keratin-rich waste;
b) grafting of the keratin micro- and/or nanoparticles via “grafting from” polymerization, with at least one monomer capable of ring opening polymerization and in presence of a catalyst; and
c) obtaining a keratin-based material.

According to a preferred embodiment, the keratin-rich waste originates from wool and/or feathers biomass.

The keratin micro- and/or nanoparticles of step a) can be obtained using any method of particle formation, for example by milling or grinding of the keratin-rich waste (native keratin source) to fine powder, preferably wool or feathers keratin-rich waste, or segregating the keratin, preferably the reduced keratin, by precipitation of the keratin micro- and/or nanoparticles from an aqueous solution obtained after an extraction process.

Keratin in reduced form can be obtained using a sulfitolysis, reduction or beta elimination process.

Sulfitolysis process is performed preferably by adding sodium metabisulfite, or sodium bisulfite or sodium sulfite, at a preferred concentration comprised between 0.1 M up to the solubility of the reducing agent measured at 95 °C, preferably comprised between 0.2 to 0.5M.

Reduction of keratin may be performed using a reducing agent such as but not limited to 2-mercaptoethanol, (tris(2-carboxyethyl)phosphine), dithiothreitol, cysteine at the preferred concentration comprised between 0.01 to up to the solubility of the reducing agent, preferably comprised between 0.2 to 5 M.

Beta elimination of keratin is performed using sodium sulfide at the preferred concentration comprised between 0.01 to up to the solubility of the reducing agent, preferably comprised between 0.2 to 5 M.

According to a preferred embodiment, the reduction of the solubilized keratin is performed using a reduction with 2-mercaptoethanol at a preferred concentration comprised between 0.1 M up to the solubility of the reducing agent, preferably comprised between 0.2 to 2 M.

According to a preferred embodiment, the purification of the keratin to remove protein denaturant and the reducing agent before forming the particles is made using dialysis or using precipitation with antisolvent, preferably using dialysis.

Preferably, dialysis is performed using dialysis tubing with the molecular weight-cut off (MWCO) between 3.5 kDa and 100 kDA, preferably 6-8 kDa.

The concentration of the aqueous solution of the resulting keratin is comprised between 1 to 100 mg of reduced keratin per ml of the solution, preferably 10 to 70 mg/ml and more preferably between 35 to 50 mg/I.

According to a preferred embodiment, a surfactant can be used to increase the extraction yield and solubility of native keratin; however, its presence is not crucial for click-reaction. Suitable surfactant is anionic or non-ionic surfactant; preferably the surfactant is selected from sodium dodecyl sulfate (SDS), Polyoxyethylene octyl phenyl ether, polyoxyethylene sorbitan monolaurate, more preferably it is sodium dodecyl sulfate.

When sodium dodecyl sulfate is used, it is preferably used in an amount comprised between 0.125 g/L to 2 g/L, preferably a concentration of 0.5 g/L of SDS in water is used.

Preferably, the keratin extraction is performed using a concentration of keratin rich waste between 1 g/L to 500 g/L, preferably between 50 g/L to 100 g/L.

Preferably, the keratin extraction is performed at a temperature comprised between 5 to 95 °C, preferably between 50 to 70 °C. According to a preferred embodiment, the keratin micro- and/or nanoparticles of step a) are obtained by precipitation of keratin in reduced form from a solution using: salting-out method, iso-electric precipitation, emulsification method, desolvation method, coacervation method, mixing with non-ionic hydrophilic polymers method or electrospraying technique, preferably using the mixing with non-ionic hydrophilic polymers method; or by, for example, milling or grinding of the keratin-rich waste (native keratin source) to fine powder, preferably wool or feathers keratin-rich waste.

Preferably, the particles size of the keratin micro- and/or nanoparticles obtained in the step a) is comprised between 10 nm up to millimeters, preferably between 50 nm and 500 nm, preferably between 60 and 200 nm.

According to a preferred embodiment, the at least one monomer capable of ROP in step b) is lactide, a lactone, a cyclic carbonate, or an epoxide, preferably is lactide.

When lactide is used as monomer, polylactic acid (PLA) is the grafting polymer.

According to a preferred embodiment, before mixing the keratin micro- and/or nanoparticles with the at least one monomer capable of ROP in step b), all reagents are purified and dried before use, as water can compromise the reaction; and/or the synthesis of the grafted keratin micro- and/or nanoparticles is carried out in an inert atmosphere.

According to another preferred embodiment, the mass ratio between the keratin micro- and/or nanoparticles and the at least one monomer capable of ROP in step b) is comprised between 120-10 and preferably is comprised between 100 and 60. In the method of the invention, the amino acids bearing hydroxyl groups (or any other functional group capable to initiate ROP) present on the keratin micro- and/or nanoparticles' surface can be used as initiators.

A solvent is added to form a stable dispersion of the reagents, namely the keratin micro-and/or nanoparticles and the at least one monomer capable of ROP. The reagents can be dispersed in any solvent that does not compromise the ring-opening polymerization and provides optimal wetting of the keratin particles and a stable dispersion. Suitable preferred solvent is selected from N,N-dimethylformamide (DMF), dichloromethane (DCM), tetrahydrofuran (THF), toluene and/or dimethyl sulfoxide (DMSO), preferably DMF.

A stable dispersion of the reagents is for example obtained using sonication, but any instrument or process that provides optimal dispersion can be used. For example, ultra-turrax and mechanical stirring can also be used to obtain a stable dispersion of the reagents.

According to a preferred embodiment, the sonication lasts at least 15 minutes, preferably 1 h, to achieve the optimal dispersion of reagents in the solvent.

A catalyst is also added in step b). In particular, any catalyst capable of ROP, preferably 1,8-diazabicyclo[5.4.0]undec-7-ene (DBU), 1,5,7-triazabicyclo[4.4.0]dec-5-ene (TBD) or 7-methyl-1,5,7-triazabicyclo[4.4.0]dec-5-ene (mTBD) can be added.

The preferred mass ratio between the keratin micro- and/or nanoparticles and the catalyst is comprised between 0.5-1,5, preferably 0.7-1.

The reaction starts with the addition of the catalyst.

The “grafting from” reaction is carried out preferably at room temperature, namely between 15 °C and 30 °C, for a time preferably comprised between 1-3 h, preferably 1,5-2,5 h (or the time needed for the optimal monomer conversion).

Then, a compound able to terminate the reaction is added. Suitable termination compound able to neutralize and deactivate the catalyst is an acid, preferably organic acid, more preferably selected from benzoic acid, acetic acid or citric acid.

When DBU catalyst is used, benzoic acid is preferred as termination compound.

Benzoic acid can also be used when TBD and mTBD catalysts are used.

According to a preferred aspect, the termination compound is added in molar quantities, preferably 2-2.5 times the quantity of the catalyst.

Once the reaction is over, the product can be purified, for example by solvent precipitation, centrifugation and/or filtration.

For example, when lactide is used in ROP and DBU is used as catalyst the purification can be performed by precipitating the polymer from any solvent for the initiator, lactide and DBU (but not for the PLA), preferably an alcohol, such as isopropanol or ethanol.

Self-polymerization of the polymer may occur. The undesired self-polymerized polymer can be further separated from the grafted keratin micro- and nanoparticles, for example by washing with a suitable solvent, such as aprotic solvents, preferably DMF or DMSO.

In step c) a keratin-based material, preferably a film, is obtained.

According to a preferred embodiment, the solution obtained in step b) is casted in step c) to obtain a keratin material, preferably a film, preferably at room temperature.

According to a preferred embodiment, the solution is preferably casted in a Petri dish and allowed to dry, preferably at the room temperature, to obtain a keratin-based material, preferably a film.

Optionally, the method of the invention may comprise the step b′) before step c):
b′) mixing the grafted keratin micro and/or nanoparticles with at least one polymer, preferably at least one biodegradable polymer, and a solvent.

Thus, according to a preferred embodiment, the method for the preparation of a keratin-based material of the present invention comprises the following steps:
a) obtaining keratin micro- and/or nanoparticles from a keratin-rich waste;
b) grafting the keratin micro- and/or nanoparticles via the “grafting from” polymerization, with at least one monomer capable of ring opening polymerization and in presence of a catalyst;
b′) mixing the grafted keratin micro- and/or nanoparticles with at least one polymer, preferably at least one biodegradable polymer, and a solvent; and
c) obtaining a keratin-based material.

According to a preferred embodiment, the at least one biodegradable polymer of step b′) is selected from polyesters, such as poly(lactic acid) (PLA), poly(butylene-adipate-co-terephthalate) (PBAT), polyhydroxyalkanoate (PHA) and/or polycaprolactone (PCL).

According to another preferred embodiment, suitable solvent of step b′) is selected from ethyl acetate, acetone, propylene carbonate, THF, DCM and/or cyrene.

The mass ratio between grafted keratin micro- and/or nanoparticles and the at least one polymer, preferably at least one biodegradable polymer, is preferably comprised in the range 1:99-30:70.

According to a preferred embodiment, when the keratin micro- and/or nanoparticles are grafted with PLA (keratin/PLA particles) and PLA is used as biodegradable polymer, the mass ratio between the keratin/PLA particles and PLA preferably is 20:80, whereas when keratin/PLA particles are mixed with PBAT as biodegradable polymer, the preferred mass ratio is 5:95.

Thus, it is an object of the invention a keratin-based material obtainable according to the method of invention, preferably in form of a film, preferably in form of a composite film when step b′) is present.

According to a preferred embodiment, the solution obtained in step b′) is casted in step c) to obtain a keratin-based material, preferably a composite film, preferably at room temperature. According to a preferred embodiment, the solution is preferably casted in a Petri dish and allowed to dry, preferably at the room temperature, to obtain a keratin-based material, preferably a composite film.

The keratin-based material obtainable according to the method of the invention, preferably film or composite film, can be reprocessed: several industrial processing methods such as extrusion, reactive extrusion, thermal compression, injection molding, injection stretch blow molding, blown film, casting, thermoforming, foaming, fibre spinning, blending, batch process and compounding are employed to process PLA and can be used for the keratin material of the invention (R. A. Ilyas et al., Polymers (2021) vol. 13(8), p. 1326, https://doi.org/10.3390/polym13081326; Satya P. Dubey et al., Vacuum, (2017) vol. 146, p. 655-663; https://doi.org/10.1016/j.vacuum.2017.07.009).

Non-modified keratin-based materials cannot be processed in this way.

Reprocessing is useful for changing the shape of the material and to recycle it several times.

The performance of the reprocessed material is comparable to the one of the materials before reprocessing.

The properties of the keratin-based material of the invention are clearly derived from the process of the invention, which allow the keratin and PLA to be bonded together.

Indeed, in the material of the invention, OH groups of the keratin are covalently bonded to the polymer.

Because keratin and PLA are bonded together, there is no common solvent for the two components. This means that the material will not dissolve in solvents such as water, which is commonly used for keratin, or solvents such as, but not limited to, chloroform, which is used to dissolve PLA. This results in increased chemical resistance of the material.

In addition, because keratin and PLA are linked, there is excellent compatibility between the two fractions. This allows the new material to be used to produce masterbatches or as an additive to other bioplastics, allowing very high loading. In the experimental part, the demonstration that up to 30% keratin biomass is present in composites, namely a loading that had never been achieved before, is present.

The keratin-based material obtainable according to the method of the invention, is characterized by having:
i) a percentage elongation at break (ε_{b}) comprised between 0.1 and 1000%, preferably between 5.3 and 136.7%; and/or
ii) an elastic modulus (Young's Modulus) (E) comprised between 50 and 2000 MPa, preferably between 106 and 850 MPa; and/or
iii) an ultimate tensile strength (δ_{b}) comprised between 0.1 and 90 MPa, preferably between 6.6 and 10.4 MPa.

The above properties, namely the percentage elongation at break (ε_{b}), an elastic modulus (Young's Modulus) (E) and the ultimate tensile strength (δ_{b}) were measured according to the International standard ISO 572-2 method.

In particular, tensile test was measured using a dual column Instron 3365 universal testing machine with a strain rate of 10 mm/min, using dumbbell-shaped samples ISO 527-2 type 5A with a thickness of 0.5 mm.

Furthermore, it is also an object of the present invention, the use of the keratin-based material obtainable according to the invention to replace plastic, in every application where commodity plastic is used, for example in the packaging sector, preferably for the packaging of a product, in coatings, in structural elements of consumer products, in biomedical applications, and agriculture.

Advantageously, the method of the invention is simple and quick.

The method of the invention allows control and tuning of the mechanical properties of the obtained keratin-based material by changing the ratio and type of reagents. For example, PLA/keratin particles can be homogeneously dispersed in polymer matrices constituted by PLA and/or PBAT. The resulted composites have improved mechanical properties.

Advantageously, the keratin-based material obtained with the method of the invention, preferably a film or a composite film, is flexible, completely biodegradable and can be used as a protein-based bioplastic alterative to oil-based plastic.

The method of the invention allows to obtain keratin-based films and/or composite films with mechanical properties suitable for use as bioplastics without the need of plasticizers or other additives.

The “grafting from” method is an efficient method for growing polyesters on the keratin particles using the —OH moieties present on the keratin particles.

In the case of use of PLA is possible to dense covering of the keratin surface with significantly polymeric chains (for example DPn=50).

Moreover, almost 25-30% of the composite can be keratin coming from waste.

### EXAMPLES

### Example 1

### Synthesis of Keratin Particles

The keratin particles in the range 100 nm to 4 μm were obtained according to the method described in the paper of Perotto G. et al., (J. Mater. Chem. B (2019), vol. 7, p. 4385-4392; DOI: 10.1039/c9tb00443b).

The keratin (reduced or in native form) was segregated into particles using any method capable to the particle formation, for example, but not limited to salting out, iso-electric precipitation, emulsification, desolvation, coacervation, mixing with non-ionic hydrophilic polymers and electrospraying technique, preferably mixing with non-ionic hydrophilic polymers.

### Solvent Selection

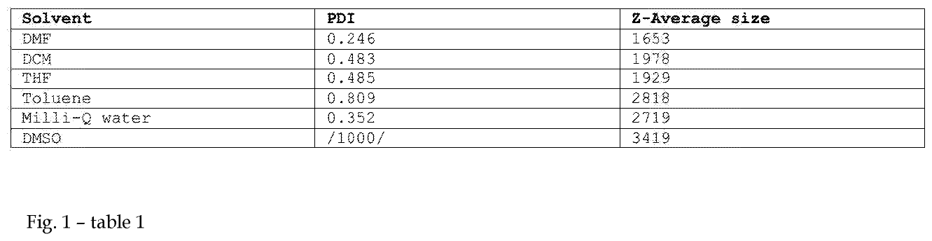

Keratin is insoluble in any organic solvent, but the wetting of the particles varies from solvent to solvent and optimal wetting is necessary to produce stable dispersions. The distribution of hydrodynamic radii, described by the polydispersity index (PDI) of keratin particles dispersion in N,N-dimethylformamide (DMF), dichloromethane (DCM), tetrahydrofuran (THF), toluene, Milli-Q water and Dimethyl sulfoxide (DMSO) were analyzed by Dynamic Light Scattering, DLS (DLS Zetasizer Anton-Paar) and the results are collected in Table 1 in FIG. 1.

### Synthesis of Keratin/PLA Particles

The reactions were carried out in a nitrogen atmosphere and absence of water, which can compromise the polymerization; therefore, all the reagents were purified and dried before use; the lactide was recrystallized and 1,8-Diazabicyclo[5.4.0]undec-7-ene (DBU) was distilled under reduced pressure. The keratin, which has been extracted and prepared in the form of keratin particles was dried overnight in the oven under a nitrogen atmosphere (at a controlled temperature) to remove traces of water.

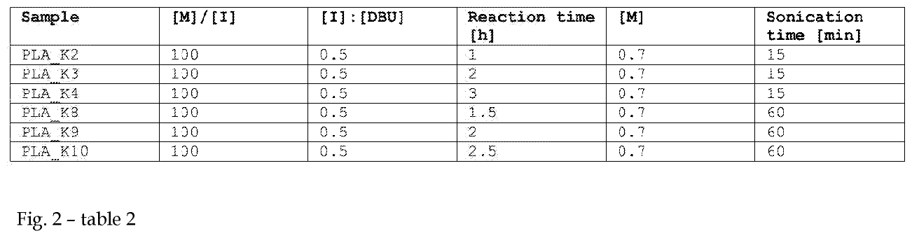

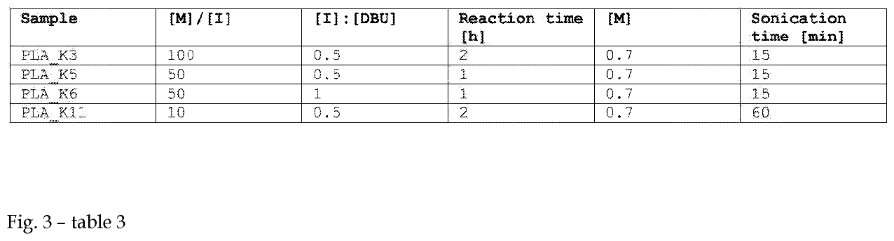

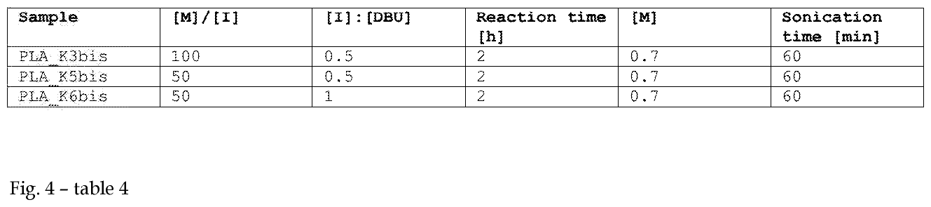

The amino acids bearing hydroxyl groups (i.e., serine, tyrosine, and threonine) or any functional group capable to ROP present on the keratin particles' surface were used as an initiator. The keratin particles were inserted into the reaction tube together with the lactide. Following the addition of the anhydrous DMF, the reaction vessel is placed in a sonication bath to achieve better dispersion of the keratin in the solvent. The reaction starts with the addition of the catalyst (DBU). Subsequently, benzoic acid is added in molar quantities equal to 2-2.5 times the quantity of the catalyst to stop the reaction. Benzoic acid has the role of neutralizing and deactivating the catalyst. Once the reaction is over, the product is purified by precipitating the polymer in isopropanol, an excellent solvent for the initiator, lactide and DBU but not for the poly(lactic acid). To optimize the reaction conditions for the system PLA/keratin (named as PLA_K), several sets of polymerizations have been conducted, varying systematically the experimental parameters that are considered more relevant (Tables 2-4 respectively in FIGS. 2-4). More precisely, we varied the ultrasonication time that is important for the formation of the colloidal dispersion. The first set of samples was prepared with 15 minutes of ultrasonication (PLA_K2, PLA_K3, PLA_K4, PLA_K5, PLA_K6, Table 2 in FIGS. 2 and 3 in FIG. 3), the second with 1 h (PLA_K8, PLA_K9, PLA_K10, PLA_K11, PLA_K2bis, PLA_K4bis, PLA_K5bis, PLA_K6bis, Tables 2-4 respectively in FIG. 2-4). Moreover, monomer/initiator ratios and initiator/catalyst ratios have been studied: the data set composed of PLA_K2, PLA_K5, PLA_K6 and PLA_K11 were developed for this purpose.

The next set of polymerizations was carried out to study the reactivity of the functional groups present on the keratin particles: PLA_K2, PLA_K3, PLA_K4, PLA_K8, PLA_K9, and PLA_K10 were produced with a focus on reaction time (1-3 h), variable that aroused interest due to the different reactivity of initiators used. It is reasonable to assume that —OH groups on keratin particles' surface do not react as good as the ones of alcoholic initiators.

### Removal of the Free PLA

To remove the physisorbed PLA from the keratin/PLA particles' surface, the following procedure has been adopted:
1) the powder is dispersed in DMF and sonicated for 10 minutes under mechanical stirring;
2) the dispersion is centrifuged for 15 minutes at 6000 rpm;
3) the solvent is removed, pure DMF is added, repeating the washing procedure 3 times;
4) the powder is dried under a vacuum.
1) to 4) procedure was repeated with DCM and THF on the same sample; the final powder was dried under vacuum overnight to eliminate any possible trace of solvent.

### Dynamic Light Scattering (DLS)

The size of keratin particles was characterized by DLS using a DLS Zetasizer Anton-Paar.

### ¹H-NMR Characterization

¹H NMR spectra were obtained with a NMR Bruker Avance 400 MHz spectrometer.

### Differential Scanning Calorimetry (DSC)

Differential Scanning Calorimetry (DSC) was performed with a DSC 1 Mettler. The same method was used for each analysis. The samples were equilibrated to −50 °C and then heated to 200 °C, the temperature was kept for 5 minutes and then the second cycle restarted from −50 °C up to 240 °C with a temperature ramp of 20 K/min.

Usually, the first heating show solvent impurity, so all the information is collected in the second heating cycle.

The data obtained with this technique can be analyzed to obtain crucial quantitative information on the nature of the two-component system, in particular regarding the properties of the polymeric component; we can extrapolate the molecular weight thanks to the Flory Fox equation (Stoddart, A., W. J. Feast, and S. P. Rannard, Synthesis and thermal studies of aliphatic polyurethane dendrimers: a geometric approach to the Flory-Fox equation for dendrimer glass transition temperature. Soft Matter (2012) vol. 8(4), p. 1096-1108):

$${T}_{g} ( {M}_{n} ) \approx {T}_{g , ∞} - K / {M}_{n} \qquad ( 1 )$$

The Flory-Fox equation relates the number-average molecular weight, Mn, to the glass transition temperature, T_{g} (in Kelvin), where T_{g, ∞} is the maximum glass transition temperature that can be achieved at a theoretical infinite molecular weight and K is an empirical parameter that is related to the free volume present in the polymer sample. The factor K is usually obtained by fitting the Flory-Fox equation to experimental data for a given polymer. If these data are not available, K can be estimated from Bicerano's equation: K=0.002715 T_{g, ∞} (Bicerano, J., Prediction of polymer properties. 2002: cRc Press).

This work uses T_{g, ∞}PLA=330 K and K=7.30×10⁴ K (Shmool, T. A. and J. A. Zeitler, Insights into the structural dynamics of poly lactic-co-glycolic acid at terahertz frequencies. Polymer Chemistry (2019) vol. 10(3), p. 351-361).

### Thermogravimetric Analysis (TGA)

The thermal degradation behavior of the keratin/PLA particles was investigated by a thermogravimetric analysis (TGA) method with a TGA Mettler. The method used consists of a heating procedure that starts from 30 °C up to 800 °C with a heating rate of 5 °C/min so all complete degradation of each sample can be monitored. All datasets are normalized on the loss value recorded at 100 degrees to eliminate the contribution due to water and the precipitation solvent.

### Scanning Electron Microscope (SEM)

The samples were imaged with a Zeiss FEG Gemini 500 Field Emission Scanning Electron Microscope.

### Film Fabrication

Considering the limited amount of keratin/PLA particles, the composites were prepared with the solution casting method. The polymer (PLA or PBAT) and the particles (PLA_K) were dispersed or dissolved in a suitable solvent (chloroform was used to process samples with PBAT and acetone was used to process the samples with PLA), also quite volatile and then the solution/dispersion was allowed to dry in a Petri glass. A PLA, a polymer grade for filament 3D printing, has been used (from Geeetech, China), Mw=183 KDa and D=1.1.

### Mechanical Testing

The mechanical testing was performed using Dinamometro Zwick Roell.

### Examples

The efficacy of the grafting process has been verified with TGA to obtain quantitative information. From the TGA analysis, it could be extrapolated the percentage of polymer grafted on the keratin surface. Thanks to DSC analysis, it was possible to confirm the presence or not of the grafted chains and to determine their molecular weight (so the number of units for each chain) thanks to Flory-Fox equation.

The distribution of hydrodynamic radii, described by PDI and Z-Average size of keratin particles are collected in Table 1 in FIG. 1. The anhydrous DMF proves to be the most suitable solvent for the reaction since the distribution of hydrodynamic radii, as described by the PDI, is the lowest.

### PLA-Keratin NMR Characterization.

Since keratin particles are insoluble in all organic solvents, NMR spectra of keratin colloids cannot provide quantitative information, which usually is obtained by integrating peaks. In fact, line broadening and long relaxation times can affect the various resonances in an unpredictable way. Nevertheless, NMR spectra of grafted keratin particles can confirm the success or failure of the polymerization reaction.

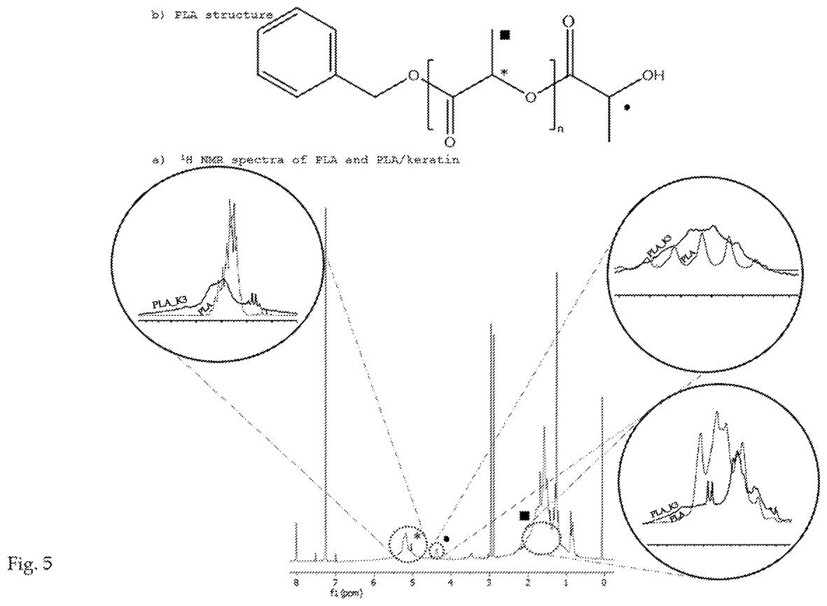

By comparing the proton spectrum of keratin particles with grafted PLA chains (PLA_K3) with the spectrum of neat PLA (Simonutti, R., et al., Morphogenic effect of common solvent in the self-assembly behavior of amphiphilic PEO-b-PLA. Polymer (2021), vol. 218, p. 123511), it is possible to appreciate that all the relevant resonances of the PLA backbone are present (FIG. 5). The peaks related to the two CH units (marked as * the one referring to the repeating monomer unit, while the terminal one is marked as •) and the methyl complex signal are well recognizable even if, clearly, they are significantly broader (marked as ▪). The broadening of the signals is direct evidence that the PLA chains are grafted on the surface of the keratin particles and thus, their motion regime is drastically slowed down.

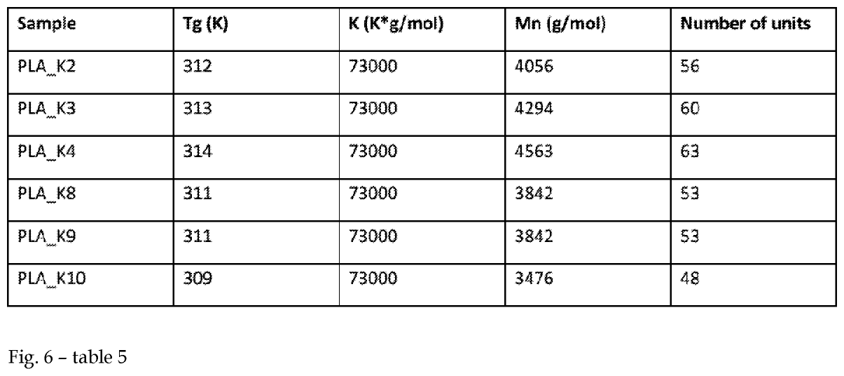

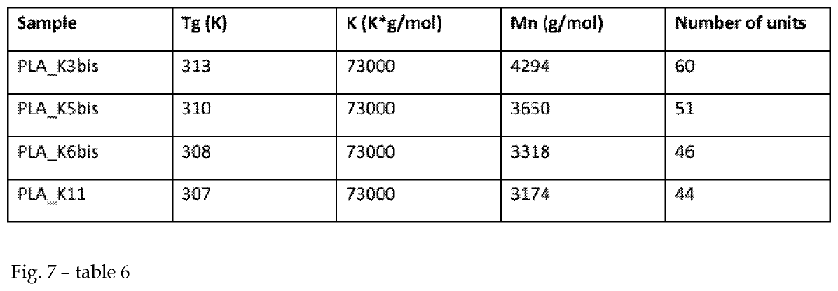

Experimental values shown in Tables 5 and 6 (respectively FIGS. 6 and 7) hardly discriminate between the investigated experimental parameters; molecular weight assessment based on Flory-Fox equation with Becerano's K-factor approximation acquired an indicative function. The whole data set is composed of similar values; some critical information could be extrapolated from the shape of Tg curves: the evaluation of the transition temperature strongly depends on the polymer section farthest from the particle. Therefore it could be hypothesized how PLA_K4 sample shows experimentally longer chains.

From TGA, it is possible to extrapolate the percentage of polymer grafted on the keratin surface, an indispensable data for modeling the system. The weight losses of the neat PLA and the keratin particles are used as references in determining the exact composition of the grafted particles.

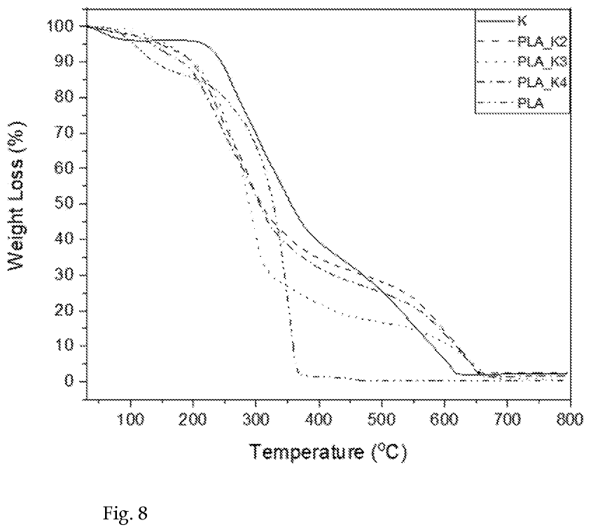

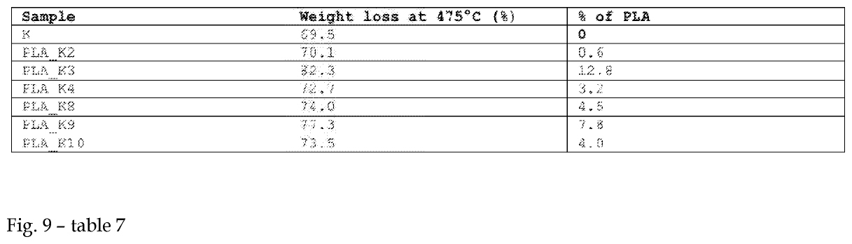

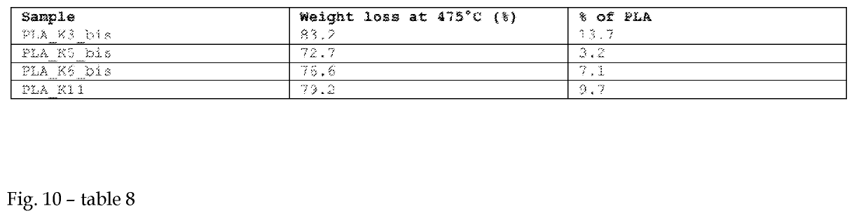

As shown in FIG. 8, the PLA sample reaches total degradation at 475 °C; the keratin sample loses only 69,5% at the same temperature. The grafted particles (PLA_K2, PLA_K3, PLA_K4) curves instead present a weight loss higher than the keratin, meaning that the different percentage lost by samples is necessarily PLA. Tables 7 and 8 (respectively FIGS. 9 and 10) report the different PLA percentages for each sample.

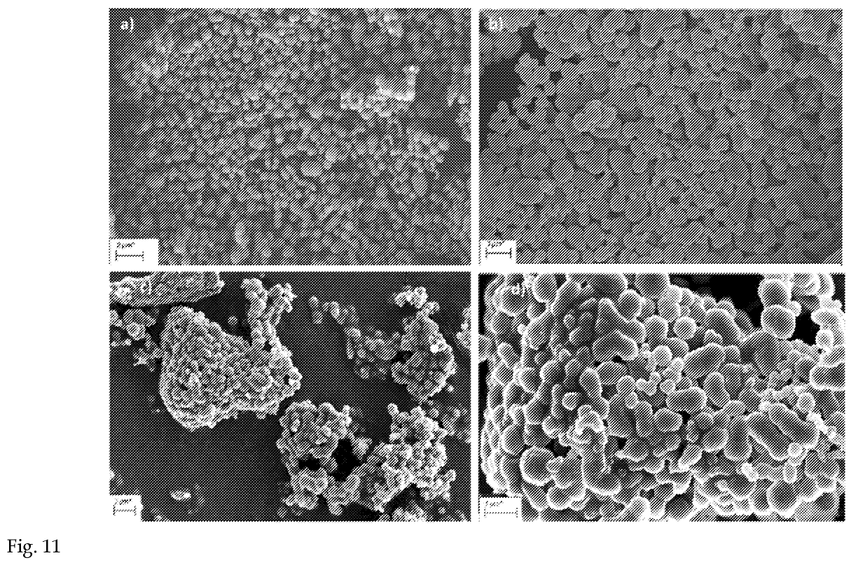

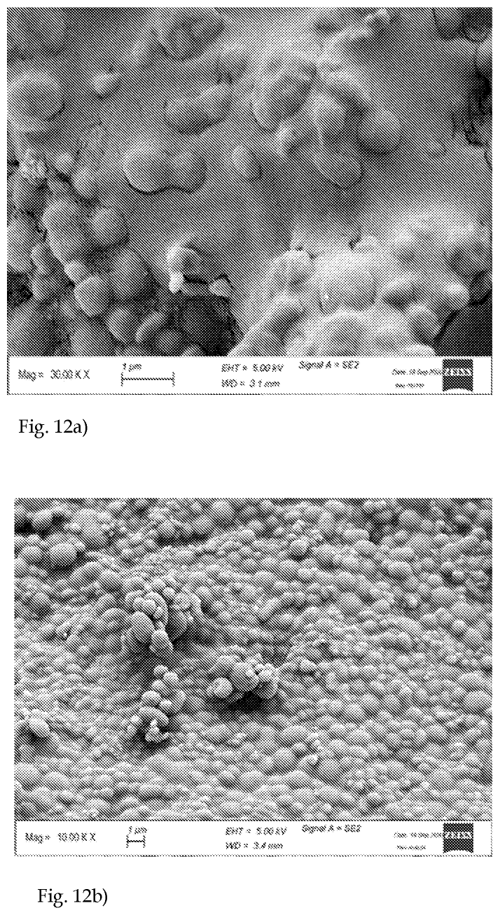

The actual dimension and morphology of the pristine keratin particles and grafted keratin particles have been characterized by SEM (FIGS. 11 and 12). Pristine keratin particles show ovoidal shapes. Also, more complex shapes are present, such as X or L shapes, as well as almost spherical particles are present.

Based on SEM images presented in FIG. 11, the average diameter of the keratin pristine particles can be evaluated, which turns out to be 0.9 μm. This value can be compared with the hydrodynamic radius coming from DLS analysis. The hydrodynamic radius describes the keratin particle interacting with a shell of solvating molecules. Keratin particles grafted with PLA provide different morphology. FIG. 12 shows the SEM images of the PLA_K3, and PLA_K6 samples. Greater compactness is observed among the particles whose boundary is not well defined. It is more difficult, in fact, to recognize the particles distinctly. The need to verify that the polymer was anchored to the particles arises from these images. Morphology of this type could indicate a polymeric blend without an actual interaction between the components of the system but the fact that the keratin particles appear to be immersed and not just resting on this matrix suggests that they are compatible with it. This compatibility can be given because PLA is covalently linked to the keratin surface. It should be considered that, based on simple thermodynamic considerations, PLA and keratin are incompatible, and their interface would be sharp and quite recognizable, similar to the case of fiberglass reinforced polymer composites. SEM images strongly support the hypothesis of PLA chains covalently linked on the surface of keratin particles.

However, in the ROP polymerization, PLA chains can grow without being initiated by the —OH present on the keratin surface; in fact, other polymerization mechanisms can be imitated by impurities present in the solvent or the reagents or by DBU. Finally, chain transfer mechanisms are also present. Therefore, a relevant issue is the characterization of grafted particles and the quantification of the amount of covalently bound polymer chains. PLA is soluble in many organic solvents, some of which have been used to solubilize PLA not bound to particles. Therefore, keratin/PLA particles were further purified to remove neat PLA.

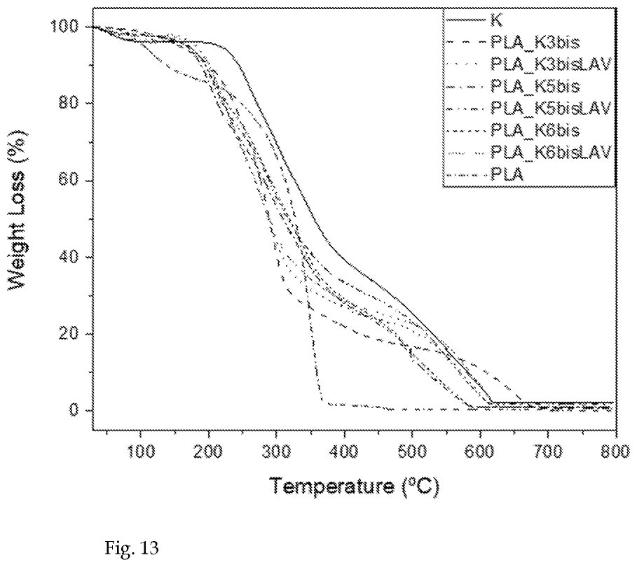

The TGA curves of the pristine and washed samples (denoted as LAV) are reported in FIG. 13.

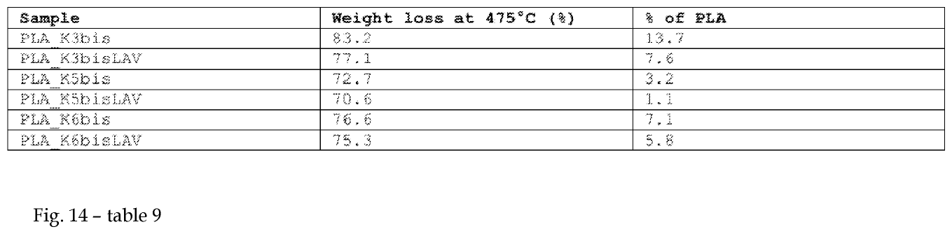

The samples that have undergone the treatment are PLA_K3bis, PLA_K5bis and PLA_K6bis. For convenience, they are reported in Table 9 in FIG. 14 with a superscript.

The TGA data show that the large part of the PLA initially present on keratin particles is covalently linked; in fact, even after a robust and repeat extraction protocol, a significant amount of PLA remains on the surface of the keratin particles.

### Film Fabrication and Characterization.

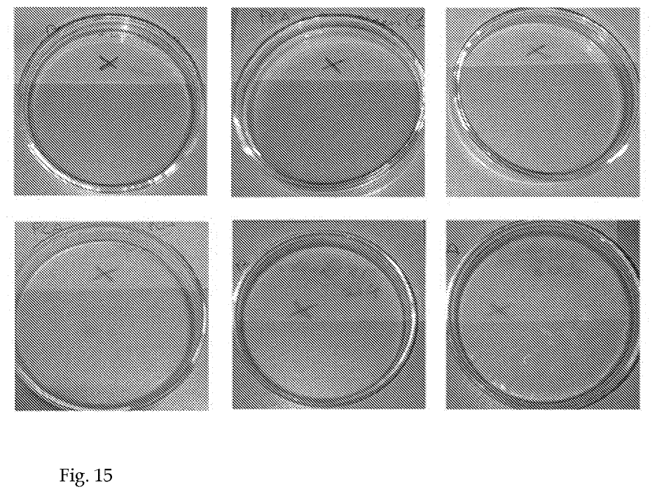

In FIG. 15 are presented the films obtained with neat PLA and PLA mixing with an increased amount of grafted keratin particles (PLA_K).

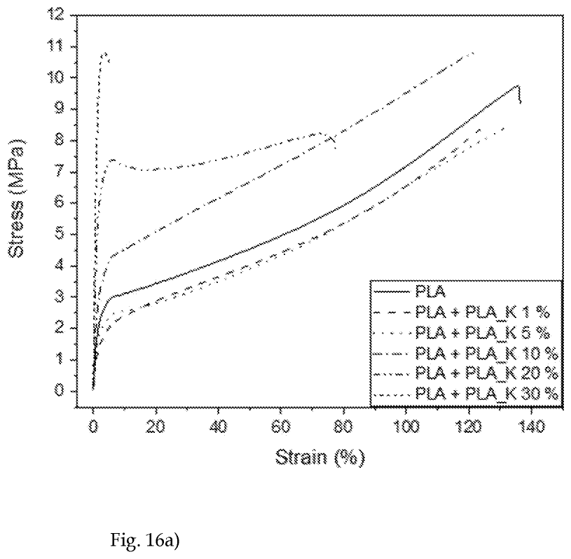

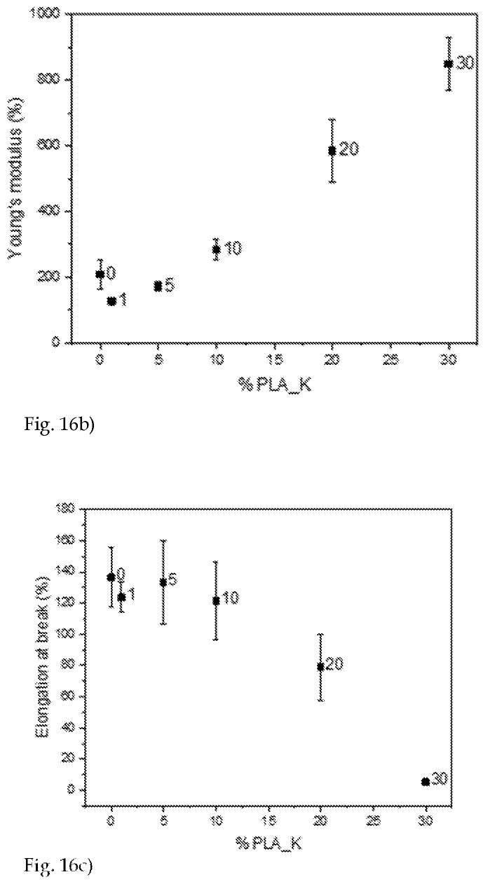

It is interesting to note that till 20% of grafted keratin particles films are cohesive and do not show cracks and wrinkles. The film with higher content of keratin (30%) instead of presents some minor fractures. Moreover, films maintain good transparency. These observations suggest that the particles are homogeneously dispersed in the polymer matrix. In FIG. 16, the stress-strain measurements on the films are reported.

Comparing the data, it is possible to state that the keratin particle increases significantly the stiffness of the PLA films reducing at the same time their stretchability. This behavior is in line with the expectations; in fact, it is well known that the introduction of hard particles (either micro- and/or nano) in the polymer bulk leads to the reduction of the mobility of the polymer chains and the increase of the mechanical moduli.

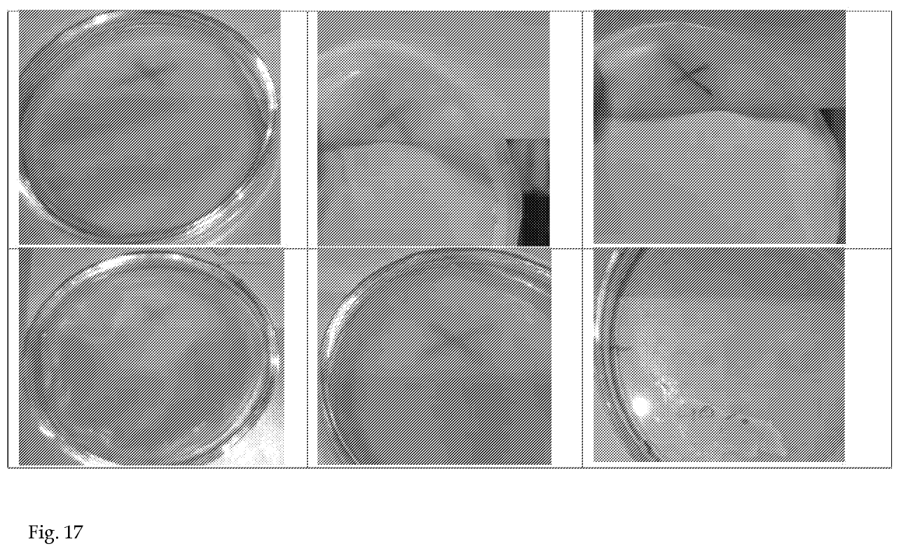

In FIG. 17, the films obtained with PBAT are depicted. In this case, the composite containing 30% of grafted keratin particles is extremely brittle, so the characterization is performed only for the other films.

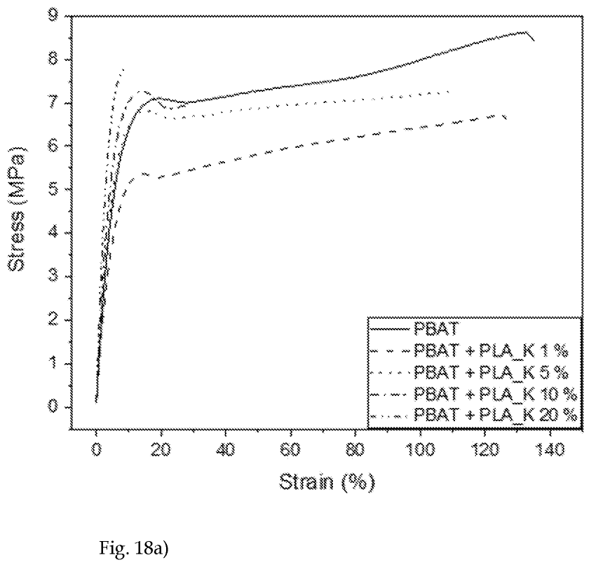

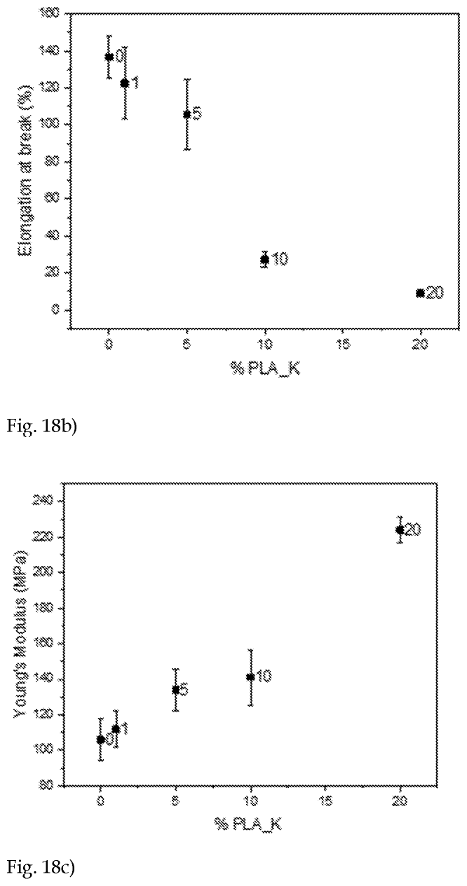

In FIG. 18, the stress-strain measurements on the films are reported.

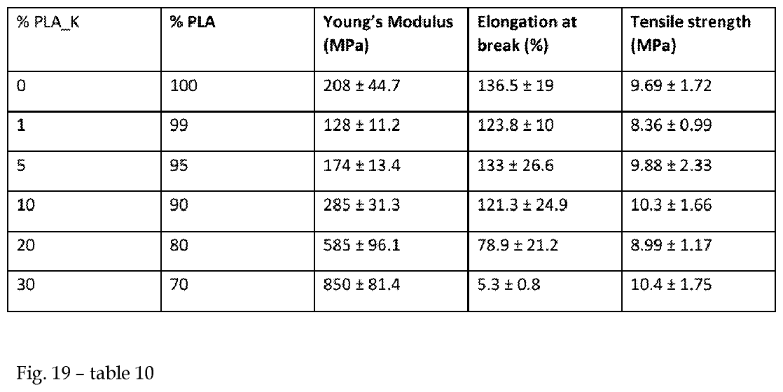

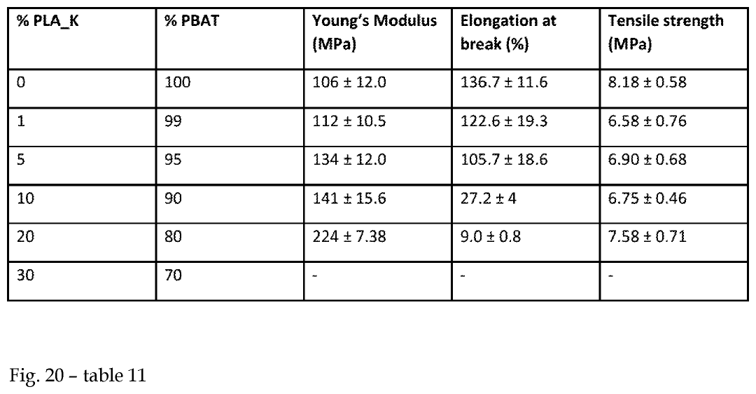

Also in this case, the presence of the keratin particles improves the mechanical properties of the films, although to a less extent. In fact, in the case of PLA, 30% of grafted keratin particles increase Young's Modulus from 208 (±44.7) MPa to 850 (±81.4) Mpa, instead of for PBAT, the maximum amount of keratin particles that can be added, maintaining cohesion, 20%, increase the Young's Modulus from 106 (±12.0) Mpa to 224 (±7.38) Mpa (Table 10 and 11 respectively in FIGS. 19 and 20).

1. A method for the preparation of a keratin-based material comprising the following steps:
a) obtaining keratin micro- and/or nanoparticles from a keratin-rich waste;
b) grafting the keratin micro- and/or nanoparticles via a “grafting from” polymerization approach, with at least one monomer capable of ring opening polymerization and in presence of a catalyst; and
c) obtaining a keratin-based material.

2. The method according to claim 1, wherein the keratin micro- and/or nanoparticles of step a) are obtained by milling or grinding to fine powder the keratin-rich waste, preferably wool or feathers keratin-rich waste, or by precipitation of keratin from an aqueous solution.

3. The method according to claim 1, wherein the keratin micro- and/or nanoparticles of step a) are obtained by precipitation of keratin from a solution using salting out method, iso-electric precipitation, emulsification method, desolvation method, coacervation method, mixing with non-ionic hydrophilic polymers method or electrospraying technique, preferably using the mixing with non-ionic hydrophilic polymers method.

4. The method according to claim 1, wherein the particles size of the keratin micro- and/or nanoparticles obtained in step a) is comprised between 10 nm up to millimeters, preferably between 50 nm and 500 nm, preferably between 60 and 200 nm.

5. The method according to claim 1, wherein the at least one monomer capable of ring opening polymerization is lactide, a lactone, a cyclic carbonate, or an epoxide, preferably is lactide.

6. The method according to claim 1, wherein the mass ratio between the keratin micro- and/or nanoparticles and the at least one monomer capable of ring opening polymerization is comprised between 120-10 and preferably is comprised between 100 and 60,

7. The method according to claim 1, wherein the catalyst in step b) is selected from 1,8-diazabicyclo[5.4.0]undec-7-ene, 1,5,7-triazabicyclo[4.4.0]dec-5-ene (TBD) or 7-methyl-1,5,7-triazabicyclo[4.4.0]dec-5-ene (mTBD).

8. The method according to claim 1, further comprising the following step b′) after the step b):
b′) mixing the grafted keratin micro- and/or nanoparticles with at least one polymer, preferably at least one biodegradable polymer, and a solvent.

9. The method according to claim 8, wherein the at least one biodegradable polymer is selected from polyesters, such as poly(lactic acid) (PLA), poly(butylene-adipate-co-terephthalate) (PBAT), polyhydroxyalkanoate (PHA) and/or polycaprolactone (PCL).

10. The method according to claim 8, wherein mass ratio between grafted keratin micro- and/or nanoparticles and the at least one polymer, preferably a biodegradable polymer, is comprised in the range 1:99-30:70.

11. The method according to claim 1, wherein the solution obtained in step c) is casted to obtain a film, preferably at the room temperature.

12. A keratin-based material obtainable according to claim 1.

13. The keratin-based material obtainable according to claim 12, in the form of a film or of a composite film.

14. The keratin-based material according to claim 12, characterized by having:
i) a percentage elongation at break (εb) comprised between 0.1-1000%; preferably 5.3 and 136.7%; and/or
ii) an elastic modulus (Young's Modulus) (E) comprised between 50 and 2000 MPa, preferably 106 and 850 MPa; and/or
iii) an ultimate tensile strength (δb) between 0.1 and 80 MPa, preferably 6.6 and 10.4 MPa.

15. A keratin-based material obtained through the reprocessing of the keratin-based material according to claim 12.

16. The keratin-based material according to claim 15, wherein the reprocessing is a process selected from extrusion, reactive extrusion, thermal compression, injection molding, injection stretch blow molding, blown film, casting, thermoforming, foaming, fibre spinning, blending, batch process and/or compounding process.

17. (canceled)

18. The method according to claim 8, wherein the solution obtained in steps c) or b′) is casted to obtain a film, preferably at the room temperature.
